(19) United States
(12) Patent Application Publication
(10) Pub. No.: US 2026/0061567 A1
(43) Pub. Date: Mar. 5, 2026

(54) PIPE WRENCH

(71) Applicant: PROXENE TOOLS CO., LTD., Taichung City (TW)

(72) Inventors: Chang-Ming WU, Taichung City (TW); Arthur WU, Taichung City (TW)

(21) Appl. No.: 18/816,589

(22) Filed: Aug. 27, 2024

(51) Int. Cl. B25B 7/10

(52) U.S. Cl. CPC B25B 7/10

(57) ABSTRACT

A pipe wrench is provided, wherein the pipe wrench includes: a first clamp body including a first handle portion, a first clamping portion and a body portion connected between the first handle portion and the first clamping portion, the body portion including a guide groove having a tooth row; a second clamp body including a second handle portion, a second clamping portion and a pivot hole; and a button inserted in the guide groove and the pivot hole, including a button base, a toothed member and an elastic member disposed between the button base and the toothed member, the button base being movable relative to the guide groove to disengage the toothed member from the tooth row, the toothed member being movable relative to the button base in a radial direction of the button and releasably engaged with the tooth row.

### BACKGROUND OF THE INVENTION

### Field of the Invention

The present invention relates to a wrench, particularly to a pipe wrench.

### Description of the Prior Art

Generally, a conventional pipe wrench includes a first clamp body and a second clamp body rotatably connected to each other. The first clamp body includes a guide groove having a tooth row. A button is inserted in a pivot hole of the second clamp body and the guide groove of the first clamp body, allowing the second clamp body to slide and swing relative to the first clamp body. Normally, the first toothed portion of the tooth row engages with the second toothed portion of the button. By pressing the button to disengage the first toothed portion from the second toothed portion, the button can slide relative to the first clamp body so that the distance between the clamping portions of the first clamp body and the second clamp body can be adjusted to changes the jaw span of the pipe wrench to be applied to pipes of different sizes or different structures.

However, in the conventional pipe wrench, since the button is integrally formed with the second toothed portion, the button has to be axially pressed to disengage the first toothed portion from the second toothed portion so that the button can slide relative to the first clamp body to adjust the jaw span of the pipe wrench for clamping a workpiece pipe. Therefore, the conventional pipe wrench is not user-friendly during repair operations and is inefficient.

Additionally, in the conventional pipe wrench as disclosed in U.S. Pat. No. 8,695,464, although the button (the pivot pin (4)) includes a spring member (spring (13)) and a ball member (ball (15)), the button is limited by the mounting clearance of the pivot hole (guiding portions (20)) of the clamp body in which the button is installed. The toothed member on the button cannot fully engage with the tooth row of the guide groove, resulting in less effective positioning. Unless the pivot hole (guiding portions (20)) has a diameter significantly larger than the button (the pivot pin (4)), which would allow the toothed member on the button to fully engage with the tooth row of the guide groove, but such a large clearance can cause the first clamp body and the second clamp body to disengage and slide relative to each other during use, leading to danger. Furthermore, during operation of the pipe wrench, if the clamp body with the button is accidentally subjected to a downward force, the toothed member on the button could easily disengage from the tooth row of the guide groove, resulting in danger.

The present invention is, therefore, arisen to obviate or at least mitigate the above-mentioned disadvantages.

### SUMMARY OF THE INVENTION

The main object of the present invention is to provide a pipe wrench which can maintain a stable structural state during use, quickly adjust the jaw span during operation, and ensure safe and efficient operation.

To achieve the above and other objects, a pipe wrench is provided, wherein the pipe wrench includes: a first clamp body including a first handle portion, a first clamping portion and a body portion connected between the first handle portion and the first clamping portion, the body including a guide groove, a tooth row being arranged on a side of the guide groove; a second clamp body including a second handle portion, a second clamping portion and a pivot hole; and a button inserted in the guide groove and the pivot hole, including a button base, a toothed member and an elastic member disposed between the button base and the toothed member, the button base being movable relative to the guide groove in an axial direction of the button to disengage the toothed member from the tooth row, the toothed member being movable relative to the button base in a radial direction of the button and releasably engaged with the tooth row.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is another exploded view of an exemplary embodiment of the present invention;

FIG. 4 is an exploded view of a button of an exemplary embodiment of the present invention;

FIG. 5 is a partial cross-sectional view showing toothed portions in an engaged state according to an exemplary embodiment of the present invention;

FIG. 6 is a partial cross-sectional view showing the toothed portions in a disengaged state as a button is pressed according to an exemplary embodiment of the present invention;

FIG. 7 is another partial cross-sectional view of an exemplary embodiment of the present invention;

FIGS. 8 to 9 are schematic views showing operation of an exemplary embodiment of the present invention; and

FIGS. 10 to 12 are schematic views of another exemplary embodiment of the present invention.

### DETAILED DESCRIPTION OF THE PREFERRED EMBODIMENTS

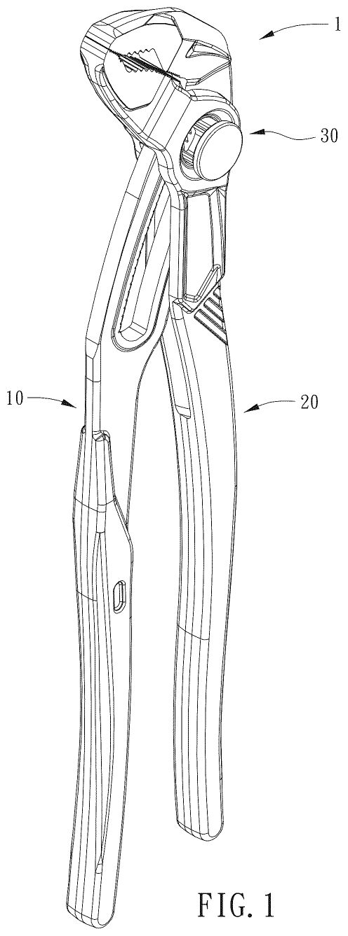

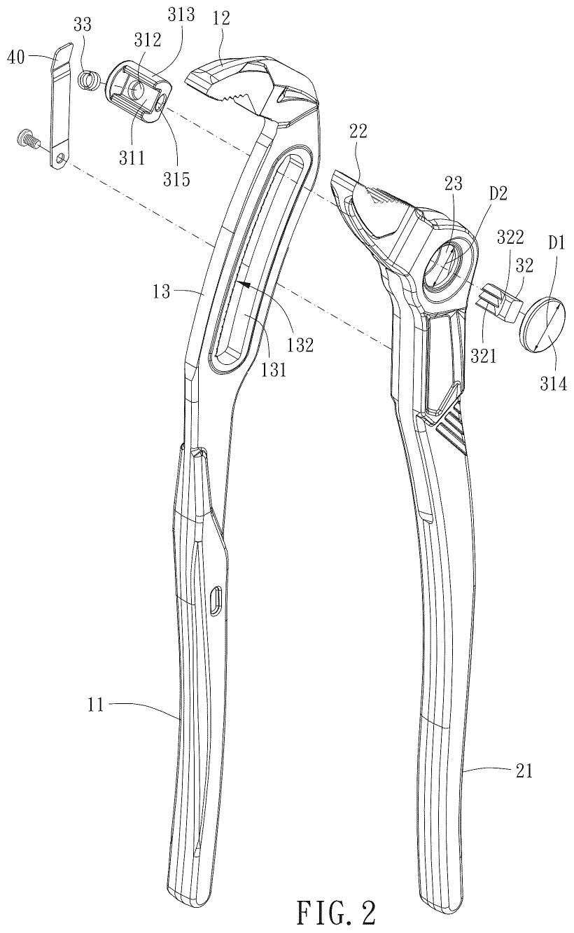

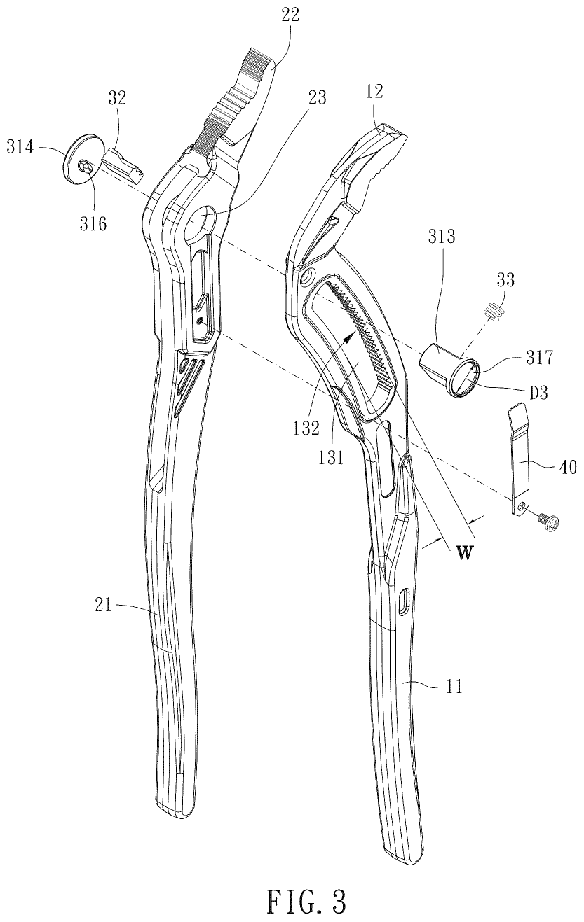

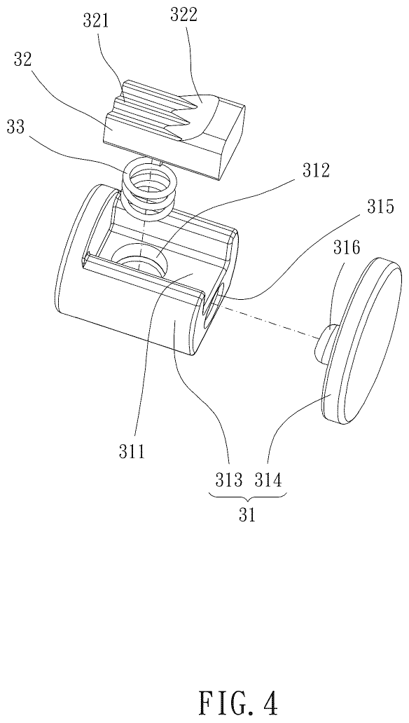

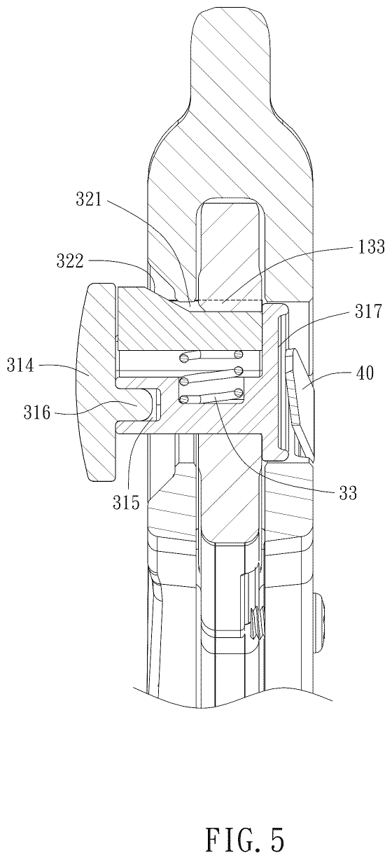

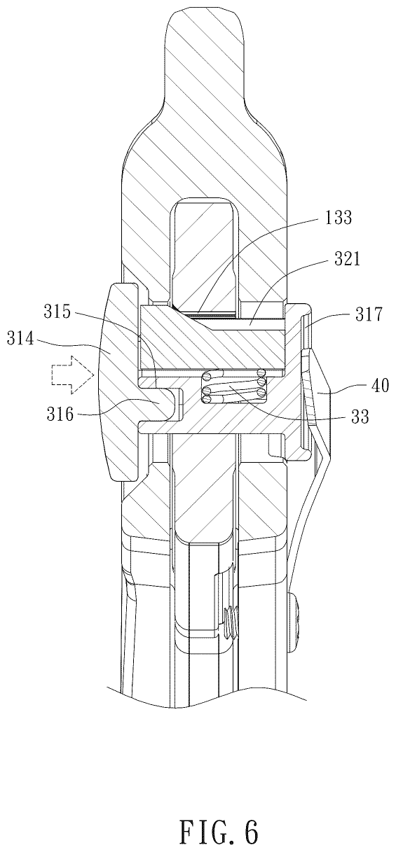

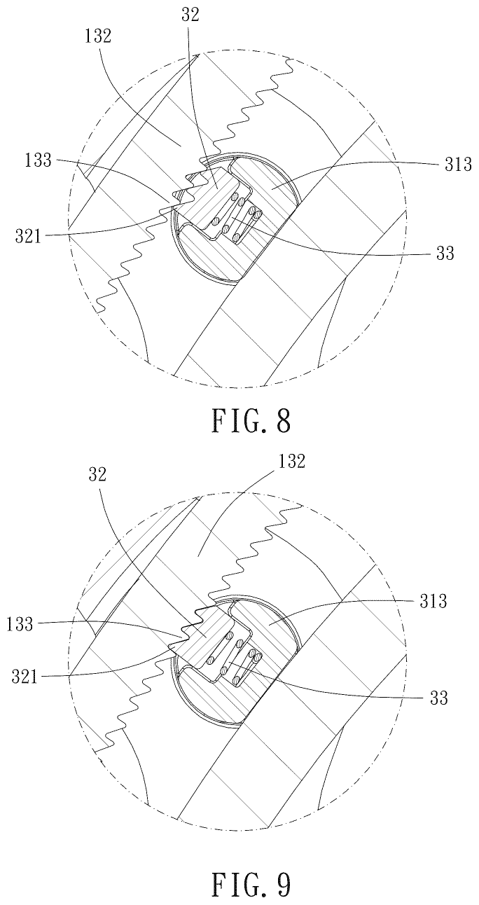

Please refer to FIGS. 1 to 9 for an exemplary embodiment of the present invention. A pipe wrench 1 of the present invention includes a first clamp body 10, a second clamp body 20, and a button 30.

The first clamp body 10 includes a first handle portion 11, a first clamping portion 12, and a body portion 13 connected between the first handle portion 11 and the first clamping portion 12. The body portion 13 includes a guide groove 131, and a tooth row 132 is arranged on a side of the guide groove 131. The second clamp body 20 includes a second handle portion 21, a second clamping portion 22, and a pivot hole 23. In this embodiment, the first handle portion 11 and the first clamping portion 12 are integrally formed of one piece or fixedly connected to each other, and the second handle portion 21 and the second clamping portion 22 are integrally formed of one piece or fixedly connected to each other; however, they may also be assembled from plural members. The button 30 is inserted in the guide groove 131 and the pivot hole 23, and the button 30 includes a button base 31, a toothed member 32, and an elastic member 33 disposed between the button base 31 and the toothed member 32. The button base 31 is movable relative to the guide groove 131 in an axial direction of the button 30 to disengage the toothed member 32 from the tooth row 132. The toothed member 32 is movable relative to the button base 31 in a radial direction of the button 30 and releasably engaged with the tooth row 132. This allows the toothed member 32 and the tooth row 132 to remain fully and stably engagement during use. Even if the second clamp body 20 is accidentally subjected to a downward force during operation, the toothed member 32 will not disengage from the tooth row 132. During adjustment, regardless of whether the button 30 is at the front, middle, rear, or any position in the guide groove 131, the jaw span between the first clamping portion 12 and the second clamping portion 22 can be quickly changed with a slight push, making the operation safe and fast.

The button base 31 and the toothed member 32 are connected to each other in an insertion manner. The toothed member 32 may be inserted within the button base 31, or the button base 31 may be inserted within the toothed member 32. In this embodiment, the button base 31 includes a receiving slot 311 receiving the toothed member 32, and the elastic member 33 is disposed between a wall of the receiving slot 311 and the toothed member 32. This modular design is advantageous for the manufacturing of the button 30 which has a relatively complex structure, and allows for replacement when the toothed member 32 wears out. The wall of the receiving slot 311 includes a mounting hole 312, and an end of the elastic member 33 is inserted in the mounting hole 312, which stabilizes and positions the elastic member 33, thereby making the engagement between the toothed member 32 and the tooth row 132 more stable and reliable.

Furthermore, the button base 31 further includes a main body 313 disposed through the guide groove 131 and the pivot hole 23, and a press plate 314 connected to an end of the main body 313. Specifically, the main body 313 includes an insertion hole 315, and the press plate 314 includes a pin 316 inserted in the insertion hole 315. A diametric dimension D1 of the press plate 314 is greater than a diametric dimension D2 of the pivot hole 23, and a diametric dimension D3 of an other end of the main body 313 is greater than a width W of the guide groove 131. Whereby, the button 30 is limited to a certain movement range and will not be disengaged from the pipe wrench 1. Preferably, the pipe wrench 1 further includes a resilient member 40 disposed on the second clamp body 20. An end face of the main body 313 includes a recession 317, and one end of the resilient member 40 elastically abuts against a bottom surface of the recession 317. Thereby, the button 30 can be normally pushed to ensure that the toothed member 32 is reliably engaged with the tooth row 132.

In this embodiment, the button 30 is non-rotatable relative to the guide groove 131. Specifically, the main body 313 is stably in surface contact with a side of the guide groove 131 opposite to the tooth row 132, and the toothed member 32 is disposed within the main body 313 and engaged with the tooth row 132. Therefore, opposing sides of the button 30 are stably abutted against opposing sides of the guide groove 131, preventing the button 30 from rotating relative to the guide groove 131. This enhances operational stability, ensures the clamping accuracy of the pipe wrench 1, and prevents the toothed member 32 from disengaging from the tooth row 132 under applied force during operation.

The toothed member 32 includes at least one second toothed portion 321 (preferably plural second toothed portions 321) engaged with the tooth row 132, and an inclined surface 322 facing the tooth row 132. Specifically, the second toothed portion 321 includes the inclined surface facing the tooth row. The top of the inclined surface 322 is higher than the top of the at least one second toothed portion 321. The inclined surface facilitates the smooth movement of the button 30 when pressed, allowing for quick and smooth release of the engagement between the toothed member 32 and the tooth row 132. Preferably, the first toothed portion 133 of the tooth row 132 and the second toothed portion 321 of the toothed member 32 are ratchet teeth inclined toward the first clamping portion 12 and are serrated. This configuration allows the button 30 to slide along the guide groove 131 when a force is applied in the length direction of the guide groove 131, thereby adjusting the distance between the first clamping portion 12 and the second clamping portion 22. The ratchet structure also prevents the toothed member 32 from disengaging from the tooth row 132 under reverse force during operation.

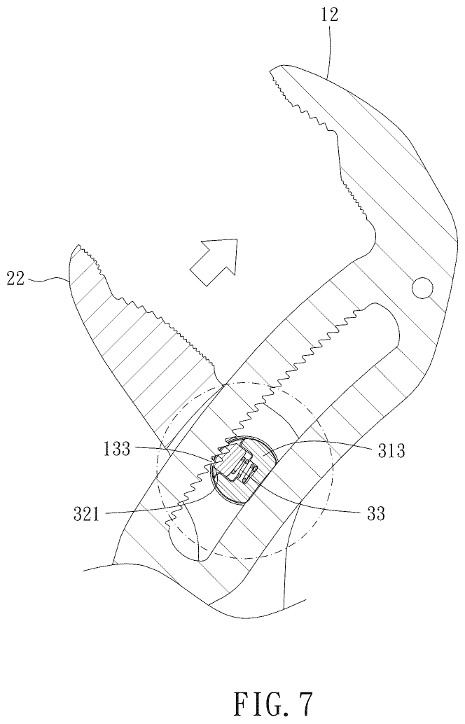

Specifically, during operation, the button 30 is pressed to disengage the toothed member 32 from the tooth row 132, allowing the first clamp body 10 and the second clamp body 20 to move relative to each other so that the button 30 moves toward the bottom end of the guide groove 131. This movement adjusts the distance between the first clamping portion 12 and the second clamping portion 22 to receive a pipe to be worked on. Then, by applying a force in the length direction of the guide groove 131 to the button 30 (e.g., moving the second clamp body 20 upward relative to the first clamp body 10), the ratchet teeth of the button 30 intermittently disengage and slide along the ratchet teeth of the guide groove 131 (FIGS. 7 to 9), which quickly reduces the distance between the first clamping portion 12 and the second clamping portion 22, thus being capable of quickly clamping the pipe.

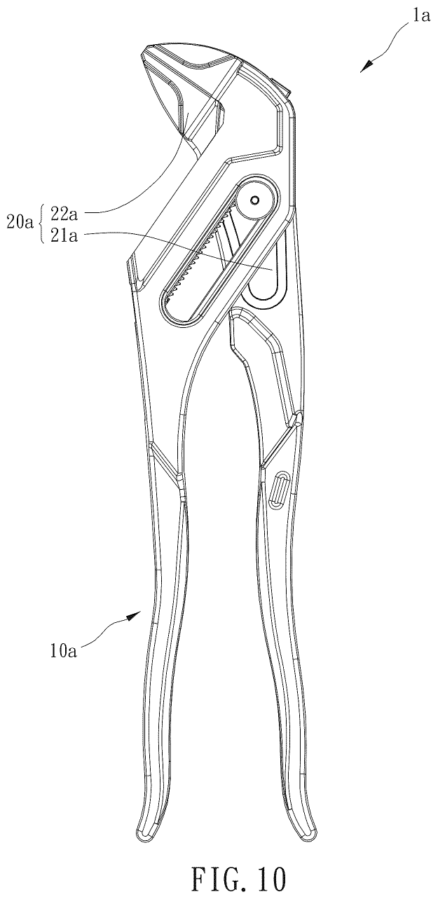

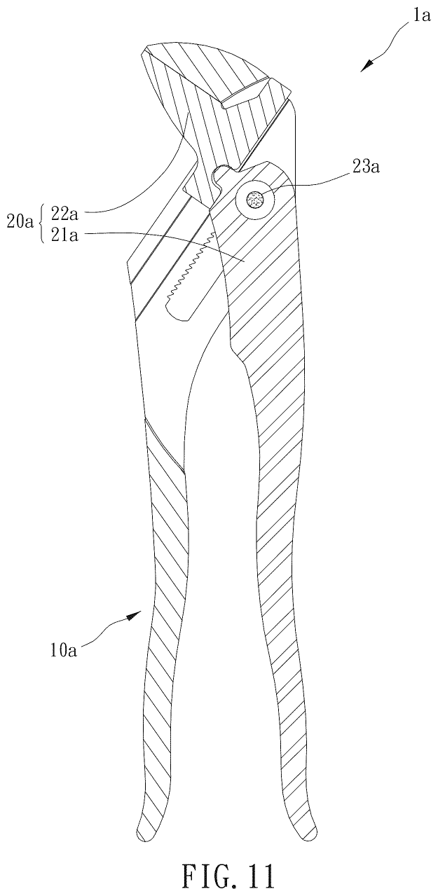

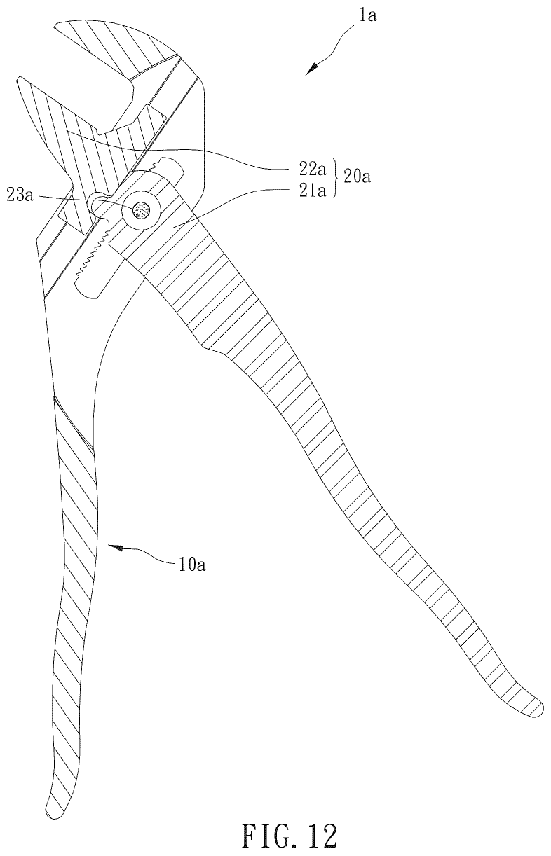

In another embodiment, as shown in FIGS. 10 to 12, the pivot hole 23a of the second clamp body 20a of the pipe wrench 1a is disposed on the second handle portion 21a. The second clamping portion 22a is movably disposed on the first clamp body 10a and cooperative with the second handle portion 21a (e.g., but not limited to a male-female engagement). The swinging of the second handle portion 21a drives the second clamping portion 22a to move relative to the first clamp body 10a to come close to or away from the first clamping portion. As such, the pipe wrench 1a can quickly clamp or release the pipe by merely swinging the second handle portion 21a back and forth with a small movement, which provides convenient, quick and efficient operation.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A pipe wrench including:
a first clamp body including a first handle portion, a first clamping portion and a body portion connected between the first handle portion and the first clamping portion, the body portion including a guide groove, a tooth row being arranged on a side of the guide groove;
a second clamp body including a second handle portion, a second clamping portion and a pivot hole; and
a button inserted in the guide groove and the pivot hole, including a button base, a toothed member and an elastic member disposed between the button base and the toothed member, the button base being movable relative to the guide groove in an axial direction of the button to disengage the toothed member from the tooth row, the toothed member being movable relative to the button base in a radial direction of the button and releasably engaged with the tooth row.

2. The pipe wrench of claim 1, wherein the button base and the toothed member are connected to each other in an insertion manner.

3. The pipe wrench of claim 2, wherein the button base includes a receiving slot receiving the toothed member, and the elastic member is disposed between a wall of the receiving slot and the toothed member.

4. The pipe wrench of claim 3, wherein the wall of the receiving slot includes a mounting hole, and an end of the elastic member is inserted in the mounting hole.

5. The pipe wrench of claim 1, wherein the button base includes a main body disposed through the guide groove and the pivot hole, and a press plate connected to an end of the main body, a diametric dimension of the press plate is greater than a diametric dimension of the pivot hole, and a diametric dimension of an other end of the main body is greater than a width of the guide groove.

6. The pipe wrench of claim 5, wherein the main body includes an insertion hole, and the press plate includes a pin inserted in the insertion hole.

7. The pipe wrench of claim 5, further including a resilient member disposed on the second clamp body, wherein an end face of the main body includes a recession, and an end of the resilient member elastically abuts against a bottom surface of the recession.

8. The pipe wrench of claim 1, wherein the button is non-rotatable relative to the guide groove.

9. The pipe wrench of claim 1, wherein the toothed member includes at least one second toothed portion engaged with the tooth row, and the second toothed portion includes an inclined surface facing the tooth row.

10. The pipe wrench of claim 1, wherein the toothed member includes at least one second toothed portion engaged with the tooth row and an inclined surface facing the tooth row, and a top of the inclined surface is higher than a top of the at least one second toothed portion.

11. The pipe wrench of claim 1, wherein a first toothed portion of the tooth row and the second toothed portion of the toothed member are ratchet teeth inclined toward the first clamping portion.

12. The pipe wrench of claim 1, wherein the pivot hole is disposed on the second handle portion, the second clamping portion is movably disposed on the first clamp body and cooperative with the second handle portion, and the swinging of the second handle portion drives the second clamping portion to move relative to the first clamp body to come close to or away from the first clamping portion.
